(19) United States
(12) Patent Application Publication
(10) Pub. No.: US 2021/0153674 A1
(43) Pub. Date: May 27, 2021

(54) RECYCLABLE STRAW

(71) Applicant: Siamak Agha Mohamaddi, Newport Beach, CA (US)

(72) Inventor: Siamak Agha Mohamaddi, Newport Beach, CA (US)

(21) Appl. No.: 17/099,405

(22) Filed: Nov. 16, 2020

Related U.S. Application Data
(60) Provisional application No. 62/939,099, filed on Nov. 22, 2019.

(51) Int. Cl. A47G 21/18; B32B 1/08; B32B 15/12; B32B 7/12; B32B 15/20

(52) U.S. Cl. CPC A47G 21/18; B32B 1/08; B32B 15/12; B32B 2307/7163; B32B 15/20; B32B 2597/00; B32B 7/12

(57) ABSTRACT

A drinking straw and a method for manufacturing the same a biodegradable straw is disclosed. The drinking straw can include a first thin, metallic layer, a second layer of biodegradable material such as paper, and optionally a third thin, metallic layer. The layers can be removably secured by applying compression, adhesive, and/or thermal energy.

### INCORPORATION BY REFERENCE TO ANY PRIORITY APPLICATIONS

Any and all applications for which a foreign or domestic priority claim is identified in the Application Data Sheet as filed with the present application are hereby incorporated by reference and made a part of the present disclosure.

### FIELD OF DISCLOSURE

This present disclosure relates to a drinking apparatus such as drinking straws for beverages.

### BACKGROUND

Drinking straws are used to siphon drinks from a glass, a bottle, or other types of containers. Usually made from plastic, drinking straws can be recycled into other plastic-based products. However, only a small portion of plastic drinking straws are recycled and the rest becomes trash that fills our cities, streets, waterways, and oceans. Because it can take up to 200 years for a plastic drinking straw to decompose naturally, it is desirable to have drinking straws that are made from biodegradable materials.

### SUMMARY OF THE INVENTIONS

An aspect of at least one of the inventions disclosed herein includes the realization that a biodegradable and/or recyclable drinking straw can be made from layers including inexpensive, recyclable or biodegradable non-waterproof layers and metal foil layers. For example, an example of an inexpensive, recyclable or biodegradable non-waterproof layer can include paper. Food grade paper is widely available in many thicknesses which are easily incorporated into structures such as drinking straws. Additionally, paper is recyclable and biodegradable. Further, paper, having sufficient thickness, can provide sufficient columnar strength to serve as a primary structural component of a structure such as a drinking straw. However, such food grade paper is not waterproof. An aspect of at least one of the inventions disclosed herein includes the realization that one or more thin metallic layers can be added to a non-waterproof biodegradable tubular structure such as that of a paper drinking straw, thereby forming a tubular structure that is recyclable and/or biodegradable which can be used as a drinking straw.

Thus, according to some embodiments, a drinking straw can include the following: (i) a tubular body of recyclable or biodegradable material, the tubular body comprising a first opening, a second opening, an intermediate section therebetween, the first opening associated with a first inner diameter and the second opening associated with a second inner diameter, the intermediate section defining a longitudinal axis and comprising a first length, the first inner diameter and the second inner diameter between about 4 mm and about 16 mm, the first length being between about 4 inches and about 18 inches; (ii) a first metallic layer comprising a first metallic material secured to an inner surface of the tubular body between the first opening and the second opening, the first metallic layer extending along the inner surface with respect to the longitudinal axis and secured to the inner surface via a first treatment, the first metallic layer having a first thickness between about 0.010 mm and 0.030 mm, the first metallic strip and the first metallic layer being waterproof and removable from the tubular body

In some embodiments, the straw can include a second metallic comprising a second metallic material secured to an outer surface of the tubular body between the first opening and the second opening, the second metallic layer extending along the outer surface with respect to the longitudinal axis and secured to the outer surface via a second treatment, the first metallic layer characterized by a second thickness ranging between about 0.010 mm and 0.030 mm, the second metallic strip and the second metallic layer being waterproof and removable from the tubular body.

In some implementations, the first treatment and the second treatment can include at least one of application of thermal treatment, application of compression force, and application of adhesive material. The application of the first treatment can seal a first plurality of overlaps of the first metallic strip, and wherein the application of the second treatment seals a second plurality of overlaps of the second metallic strip.

In some implementations, the drinking straw can include a laminate layer covering an inner surface of the first metallic layer. The first metallic layer can extend helically along the inner surface at a first angle with respect to the longitudinal axis, and the second metallic layer can extend helically along the outer surface at a second angle with respect to the longitudinal axis.

According to another aspect, a drinking straw can include the following: (i) a tubular body of recyclable or biodegradable material, the tubular body comprising a first opening, a second opening, an intermediate section therebetween, the first opening associated with a first inner diameter and the second opening associated with a second inner diameter, the intermediate section defining a longitudinal axis and comprising a first length; and (ii) a first metallic layer secured to an inner surface of the tubular body between the first opening and the second opening, the first metallic strip secured to the inner surface via a first treatment, the first metallic layer being removable from the tubular body.

In some embodiments, the straw can include a second metallic layer secured to an outer surface of the tubular body between the first opening and the second opening, the second metallic layer secured to the outer surface via a second treatment, the second metallic strip and the second metallic layer being removable from the tubular body.

In some embodiments, the first metallic layer can include a first metallic strip extending helically along the inner surface of the tubular body at a first angle with respect to the longitudinal axis. The second metallic layer can include a second metallic strip extending helically along the outer surface of the tubular body at a second angle with respect to the longitudinal axis. The first treatment and the second treatment can include at least one of applying compression force, applying thermal energy, and applying adhesive material.

In some embodiments, the first inner diameter and the second inner diameter can range between about 4 mm and about 16 mm. The first length can range between about 4 inches and about 12 inches. The drinking straw can include a laminate layer covering an inner surface of the first layer. The first layer can be characterized by a first thickness, and the second layer can be characterized by a second thickness. The first thickness can be between about 0.010 mm and about 0.030 mm, and the second thickness can be between about 0.010 mm and about 0.030 mm. The first thickness can be greater than the second thickness. The first thickness can be between about 0.018 mm and about 0.030 mm, and the second thickness can be between about 0.012 mm and about 0.024 mm.

In some embodiments, the first and second metallic layers can be waterproof.

According to another aspect, a method of manufacturing a straw can include the following: (i) applying a first strip of a first metallic material about an outer surface of a rod to form a first layer, the first layer having an inner surface and an outer surface, the inner surface of the first layer positioned adjacent to the outer surface of the rod, the outer surface of the first layer positioned radially distal from the outer surface of the rod; (ii) applying a second strip of a biodegradable material about the outer surface of the first layer to form a second layer, the second layer having an inner surface and an outer surface, the inner surface of the second layer positioned adjacent to the outer surface of the first layer, the outer surface of the second layer positioned radially distal from the outer surface of the first layer; and (iii) applying a first treatment to the first and second layers.

In some embodiments, the method can include applying a third strip of a second metallic material about the outer surface of the second layer to form a third layer, the third layer having an inner surface and an outer surface, the inner surface of the third layer positioned adjacent to the outer surface of the second layer, the outer surface of the third layer positioned radially distal from the outer surface of the second layer; applying a second treatment to the first, second, and third layers; and removing the rod.

In some embodiments, the biodegradable material can be paper. The method can further include applying a laminate layer to an inner surface of the first tubular layer. The first and second treatments can include at least one of applying compression force, applying thermal energy, and applying adhesive material. The first strip can extend helically along the outer surface of the rod at a first angle with respect to the longitudinal axis. The second strip can extend helically along the outer surface of the first layer at a second angle with respect to the longitudinal axis. The third strip can extend helically along the outer surface of the second layer at a third angle with respect to the longitudinal axis.

### BRIEF DESCRIPTION OF THE DRAWINGS

FIG. 1A is a perspective view of an embodiment of a biodegradable straw.

FIG. 1B is a cross-sectional view of the embodiment of the biodegradable straw of FIG. 1A.

FIG. 1C is a perspective view of another embodiment of a biodegradable straw.

FIG. 1D is a cross-sectional view of the embodiment of the biodegradable straw of FIG. 1C.

FIG. 1E is an illustration of an embodiment of a method of manufacturing a biodegradable straw.

FIG. 2A is a flow diagram of an embodiment of a method of manufacturing a biodegradable straw.

FIG. 2B is a flow diagram of an embodiment of another method of manufacturing a biodegradable straw.

FIG. 3A illustrates an embodiment of a material for manufacturing a biodegradable straw.

FIG. 3B illustrates a cross-sectional view of the embodiment of the material of FIG. 3A.

FIG. 3C illustrates of an embodiment of another method of manufacturing a biodegradable straw using the material of FIG. 3A.

FIG. 3D illustrates a cross-sectional view of an embodiment of a biodegradable straw.

FIG. 3E illustrates a cross-sectional view of another embodiment of a biodegradable straw.

FIG. 3F is a flow diagram of an embodiment of another method of manufacturing a biodegradable straw.

### DETAILED DESCRIPTION

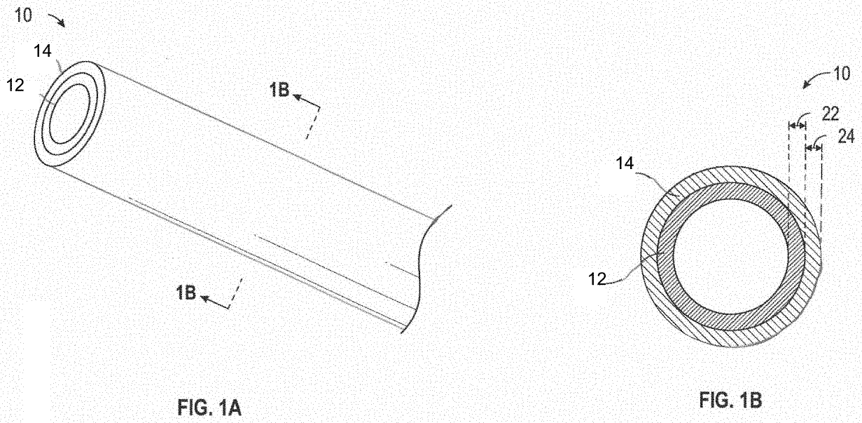

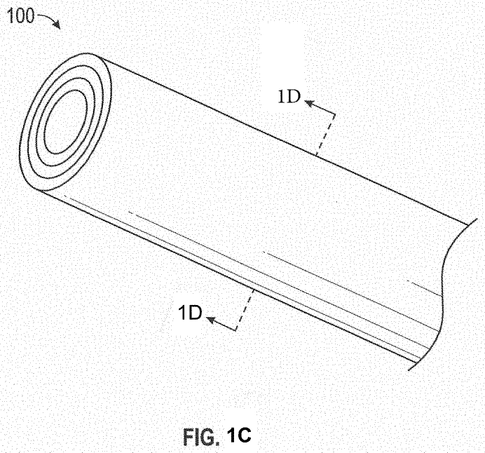

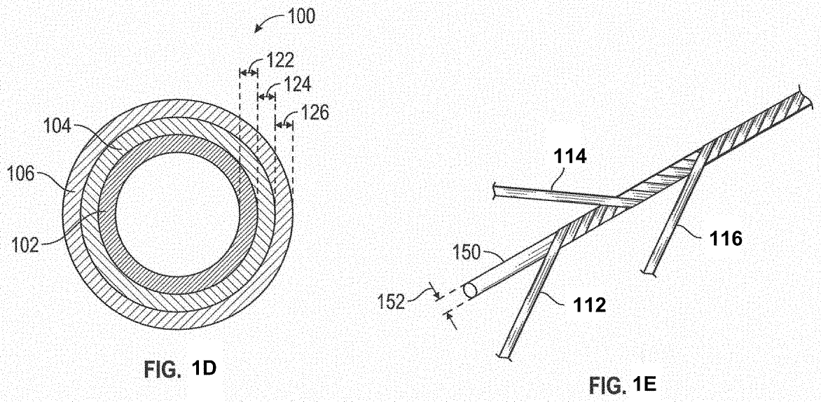

Referring to FIGS. 1A and 1B, an example of a biodegradable drinking straw 10 is disclosed. The biodegradable straw 10 can include one or more layers. The one or more layers can be made of the same or different materials. The one or more layers can be made from various recyclable and/or biodegradable materials.

The biodegradable straw 10 can include a first layer 12 and a second layer 14. The first layer 12 can be made of a first material and optionally can be a thin recyclable material. In some embodiments, the first layer 12 can be metallic. For example, the first layer 12 can be a thin layer of aluminum.

The second layer 14 can be made of a second material. Optionally, the second layer 14 can be made of a thin layer of recyclable and/or biodegradable material. For example, in some embodiments, the second layer 14 can be made out of a non-waterproof paper or other biodegradable material. In some embodiments, the second layer 14 can be made sufficiently thick so as to provide structural integrity to the drinking straw 10, described in greater detail below.

FIG. 1B illustrates a cross-sectional view of the straw 10. The first layer 12 and the second layer 14 can form separate elongated tubular layers. The first layer 12 can be the innermost layer of the straw 10. The first layer can have an inner surface defining an inner surface of the straw 10. The first layer 12 can have an outer surface contacting an inner surface of the second layer 14.

The second layer 14 can be formed on an outer surface of the first layer 12. The second layer 14 can have an inner surface that contacts the outer surface of the first layer 12. The straw 10 can include other layers as well.

The layers of the straw 10 can be removably secured to each other such that the layers can be removed for recycling. For example, the first layer 12 can be made of a thin aluminum material and can be removably attached to the inner surface of the second layer 12, such that the first layer 12 and the second layer 14 can be removed, collected, and recycled. The layers of the straw 10 can be removed by application of one or more treatments such as thermal and/or chemical treatment. The layers can be removed by applying pressure or other techniques.

The first layer 12 and the second layer 14 can have the same or different thicknesses. The first layer can have the first thickness 22 and the second layer 14 can have a second thickness 24. The thicknesses of the layers can vary between about 0.010 millimeters and about 0.04 millimeters, between about 0.015 millimeters and about 0.035 millimeters, between 0.020 millimeters and about 0.030 millimeters, between about 0.024 millimeters and about 0.026 millimeters, or about 0.010 millimeters, 0.015 millimeters, 0.020 millimeters, 0.025 millimeters, 0.030 millimeters, 0.035 millimeters, 0.040 millimeters, or between ranges of any two of the aforementioned values.

In some embodiments, the first thickness 22 of the first layer 12 can be between about 0.016 millimeters and about 0.030 millimeters. Additionally and/or alternatively, the first thickness can be less than, equal to, or greater than the second thickness 24.

The thicknesses can be constant or vary along the length of the straw 10. An aspect of at least one of the inventions disclosed herein includes a realization that a multilayered, biodegradable and/or recyclable beverage straw can be made efficiently by providing a thin metallic inner layer and an outer, non-waterproof layer that provides structural integrity, while the inner metallic layer provides a thin, lightweight waterproof layer. In such an embodiment, the inner layer 12 can maintain the integrity of the inner surface of the drinking straw 10 during use even though the second layer 14 might absorb some beverage during use.

FIGS. 1C and 1D illustrate a modification of the straw 10, identified generally by the reference numeral 100. The biodegradable straw 100 can include one or more layers. The one or more layers can be made of same or different materials. The one or more layers can be made from various recyclable and/or biodegradable materials.

The biodegradable straw 100 can include a first layer 102, a second layer 104, and a third layer 106. The first layer 102 can be made of a first material. Optionally, the first layer 102 can be made of a thin recyclable material. The first layer 102 can be metallic. For example, the first layer 102 is a thin layer of aluminum.

The second layer 104 can be made of a second material. Optionally, the second layer 104 can be made of a thin layer of a recyclable and/or a biodegradable material. For example, the second layer 104 can be made out of paper or other biodegradable materials.

The third layer 106 can be made of a third material. The third material can be recyclable. The third layer 106 can be metallic. For example, the third layer 106 is a thin layer of aluminum.

FIG. 1D illustrates a cross-sectional view of an example of the biodegradable straw 100. The first layer 102, the second layer 104, and the third layer 106 of the biodegradable straw 100 can form separate elongate tubular layers. The first layer 102 can be the innermost layer of the biodegradable straw 100. The first layer 102 can have an inner surface defining an inner surface of the biodegradable straw 100. The first layer 102 can have an outer surface contacting an inner surface of the second layer 104.

The second layer 104 can be formed on an outer surface of the first layer 102. The second layer 104 can have an inner surface that contact the outer surface of the first layer 102. The biodegradable straw 100 can include the third layer 106. The third layer 106 can be formed on an outer surface of the second layer 104 such that the second layer 104 is positioned between the first layer 102 and the third layer 106.

The layers of the biodegradable straw 100 can be removably secured to each other such that the layers can be removed for recycling. For example, as discussed above, the first layer 102 and the third layer 106 can be made of thin aluminum material. The first layer 102 and the third layer 106 can be removably attached to the inner surface and the outer surface of the second layer 104, respectively, such that the first layer 102 and the third layer 104 can be removed, collected, and recycled. The layers of the biodegradable straws 100 can be removed via application of one or more treatments such as thermal and/or chemical treatment. The layers can be removed by applying pressure.

The first layer 102, the second layer 104, and the third layer 106 can have the same or different thicknesses. The first layer 102 can have a first thickness 122. The second layer 104 can have a second thickness 124. The third layer 106 can have a third thickness 126. The thicknesses of the layers can vary between about 0.010 mm and about 0.040 mm, between about 0.015 mm and about 0.035 mm, between about 0.020 mm and about 0.030 mm, between about 0.024 mm and about 0.026 mm, or about 0.010 mm, 0.015 mm, 0.020 mm, 0.025 mm, 0.030 mm, 0.035 mm, 0.040 mm, or between ranges of any two of the aforementioned values.

In some examples, the first thickness 122 of the first layer 102 can be between about 0.016 mm and about 0.030 mm. Additionally and/or alternatively, the third thickness 126 of the third layer 106 can be between about 0.010 mm and about 0.022 mm. The first thickness 122 can be less than, equal to, or greater than the second thickness 124 of the second layer 104. Likewise, the third thickness 126 can be less than, equal to, or greater than the second thickness 124 of the second layer 104.

The thicknesses (for example, the first thickness 122, the second thickness 124, and the third thickness 126) can be constant or vary along the length of the biodegradable straw 100. An aspect of at least one of the inventions disclosed herein includes the realization that a multi-layered biodegradable and/or recyclable beverage straw can be made efficiently when the inner liquid barrier (for example, the first layer 102) of the beverage straw is thicker than the outer liquid barrier (for example, the third layer 104).

FIG. 1E is an illustration of a method of manufacturing the biodegradable straw 100. The first layer 102 can be formed using a first strip 112. The first strip 112 can be made from a recyclable material. In some examples, the first strip 112 can be made from aluminum foil. The third layer 106 can be formed using a third strip 116. The third strip 116 can be made form a recyclable material. In some examples, the first strip 116 can be made from aluminum foil. The first strip 112 and the third strip 116 can be made from the same material or different materials.

The second layer 104 can be formed using a second strip 114. The second strip 114 can be made from a recyclable and/or biodegradable material. In some examples, the second strip 114 can be made from a renewable material such as cardboard paper, hemp paper, or other paper-based materials.

Thicknesses of the first strip 112, the second strip 114, and the third strip 116 can correspond to the first thickness 122 of the first layer 102, the second thickness 124 of the second layer 104, and the third thickness 126 of the third layer 106, respectively. There are other different methods of forming the first, second, and third layers.

The first strip 112 can be applied about an outer surface of an elongate metal core or tube 150, which can have a cylindrical outer surface, to form the first layer 102. The second strip 114 can be applied about an outer surface of the first layer 102 to form the second layer 104. The third strip 116 can be applied about the outer surface of the second layer 104 to form the third layer 106.

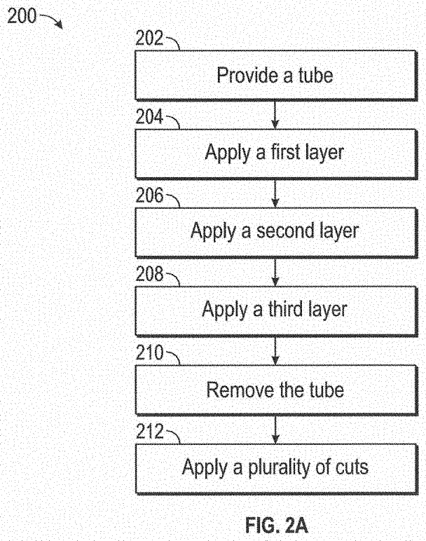

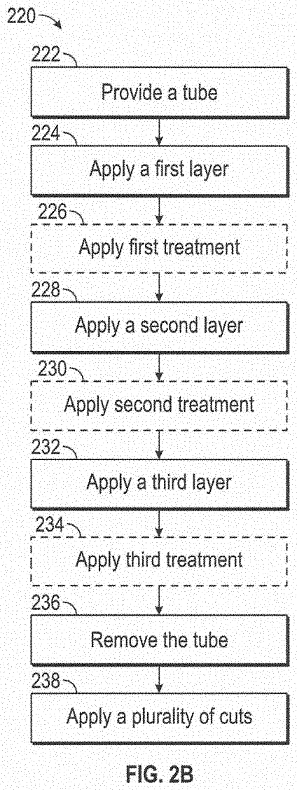

Referring to FIGS. 2A and 2B, modifications of the method of manufacturing the biodegradable straw 100 of FIGS. 1A and 1B are described. A method 200 of manufacturing the biodegradable straw can include the step of providing an elongate rod or core 150 at step 202 (see FIG. 1C). The elongate core 150 can have a diameter 152 (see FIG. 1C) and sufficient strength for resisting forces generate during the manufacturing method disclosed below. In some embodiments, the core can be made from food grade stainless steel, i.e., a stainless steel appropriate for manufacturing food handling products. The diameter 152 can be between about 6 mm and about 16 mm, between about 8 mm and about 14 mm, between about 10 mm and about 12 mm, or about 6 mm, 8 mm, 10 mm, 12 mm, 14 mm, 16 mm, or ranges between any of the aforementioned values. The diameter 152 of the elongate core 150 can be associated with an inner diameter of the biodegradable straw 100. In this regard, the diameter 152 can be varied to vary inner radius of the biodegradable straws 100.

At step 204, the first strip 112 can be applied on an outer surface of the elongate core 150 (see FIG. 1C). In some examples, the first strip 112 can be helically wrapped around the outer surface of the elongate core 150. The first strip 112 can be wrapped around the elongate core 150 at a first angle with respect to a longitudinal axis of the core 150, a sufficient number of turns such that the first strip 112 forms a first layer 102 of a length at least as long as the desired length of the biodegradable straw 100. The first strip 112 can form the first layer 102 of the biodegradable straw 100. The first strip 112 can be recyclable. The first strip 112 can be metallic. For example, the first strip 112 can be a strip of aluminum.

In some examples, the first strip 112 can be helically wrapped around the elongate core 150 such that each turn of the first strip 112 creates an overlap that includes an overlapped portion and an overlapping portion of the first strip 112. In other examples, the first strip 112 can be helically wrapped around the elongate core 150 such that each turn of the first strip 112 completely covers the outer surface of the elongate core 150 without creating any overlap. In this regard, the edges of the first strip 112 can be aligned next to each other while completely covering the outer surface of the elongate core 150.

At step 206, a second strip 114 can be applied on an outer surface of the first layer 102 formed by the first strip 112 (see FIG. 1C). The second strip 114 can be wrapped around the first layer 102 at a second angle with respect to a longitudinal axis of the core 150. The second angle can be the same as or different from the first angle. The second strip 114 can form the second layer 104 of the biodegradable straw 100. The second strip 114 can be recyclable and/or biodegradable. In some examples, the second strip 202 can be a strip of cardboard or other paper-based products.

In some examples, the second strip 114 can be helically wrapped such that each turn of the second strip 114 creates an overlap that includes an overlapped portion and an overlapping portion of the second strip 114. In other examples, the second strip 114 can be helically wrapped around the first layer 102 such that each turn of the second strip 114 completely covers the outer surface of the first layer 102 without creating any overlap. In this regard, the edges of the second strip 114 can be aligned next to each other while completely covering the outer surface of the first layer 102.

At step 208, a third strip 116 can be applied on an outer surface of the second layer 104 (see FIG. 1C). The third strip 116 can be helically wrapped around an outer surface of the second layer 104. The third strip 116 can be wrapped around the second layer 104 at a third angle with respect to a longitudinal axis of the core 150. The third strip 116 can form the third layer 106 of the biodegradable straw 100. The third strip 116 can be recyclable. The third strip 116 can be metallic. For example, the third strip 116 can be a strip of aluminum. The third angle can be the same as the first and/or second angles or it can be different from both of the first and second angles. As such, a 3-layer tube is formed.

In some examples, the third strip 116 can be helically wrapped such that each turn of the third strip 116 creates an overlap that includes an overlapped portion and an overlapping portion of the third strip 116. In other examples, the third strip 116 can be helically wrapped around the second layer 104 such that each turn of the third strip 116 completely covers the outer surface of the second layer 104 without creating any overlap. In this regard, the edges of the third strip 116 can be aligned next to each other while completely covering the outer surface of the second layer 102. In other embodiments, the first, second, and third layers are wrapped in other directions, for example, parallel with each other, non-helical, or other directions.

At step 210, the elongate core 150 can be removed. At step 212, one or more cuts can be to cut the resulting 3-layer tube to the desired length, which can be any length. Typically drinking straws are not less than 4 inches, although it is possible to make straws shorter than 4 inches, and usually not longer than 18 inches, although it is possible to make longer straws. Often the cuts made in Step 210 would be made to cut the resulting 3-layer tube into lengths between 4 and 12 inches. Other lengths can also be used. As such, one or more biodegradable straws 100 can be formed. Optionally, a thin film of impermeable and/or water resistant material can be applied to the biodegradable straws 100. In some examples, the biodegradable straws 100 can be dipped in a container of liquefied impermeable and/or water resistant material. The impermeable and/or water resistant material can be a type that is safe for consumption.

FIG. 2B illustrates another method 220 for manufacturing the biodegradable straw 100. At step 222, the elongate core 150 can be provided. At step 224, the first layer 102 can be applied. The first layer 102 can be applied to the elongate core 150 by wrapping the first strip 112 about the outer surface of the elongate core 150. The first layer 102 can be helically applied to the outer surface of the elongate core 150. In some examples, the first strip 112 can be helically wrapped around the elongate core 150 such that each turn of the first strip 112 creates an overlap, which can include overlapping portions and overlapped portions of the first strip 112. In other examples, the first strip 112 can be helically wrapped the elongate core 150 such that each turn of the first strip 112 does not create any overlap and completely covers the outer surface of the elongate core 150.

At step 226, a first treatment can be applied to the first layer 102. The treatment to the first layer 102 can include at least one of: application of thermal energy, application of pressure, or application of adhesive. Other types of treatment can be applied to removably secure the first layer 102. The first treatment of the first layer 102 can secure edges of the first strip 112. For example, the first treatment can secure overlapping portions and overlapped portions of the first strip 112. The first treatment can secure the edges of the first strip 112 to the outer surface of the first strip 112.

At step 228, the second layer 104 can be applied. The first layer 102 can be applied by wrapping the second strip 114 about the outer surface of the first layer 102. The second strip 114 can be helically applied. In some examples, the second strip 114 can be helically wrapped around the first layer 102 such that each turn of the second strip 114 creates an overlap, which can include overlapping portions and overlapped portions of the second strip 114. In other examples, the second strip 114 can be helically wrapped around the first layer 102 such that each turn of the second strip 114 does not create any overlap and completely covers the outer surface of the first layer 102.

At step 230, a second treatment can be applied to the second layer 104. As discussed above, the treatment to the second layer 104 can include at least one or more of the following: application of thermal energy, application of pressure, and/or application of adhesive. Other types of treatment can be applied to the second layer 104 to removably secure the second strip 114. The treatment of the second layer 104 can secure the edges of the second strip 114. In some examples, the second treatment can secure overlapping portions of the second strip 114 and the overlapped portions of the second strip 114. The second treatment can secure the edges of the second strip 114 to the outer surface of the second strip 114. Additionally and/or alternatively, the treatment of the second layer 104 can secure the second strip 114 to an outer surface of the first layer 102.

At step 232, the third layer 106 can be applied. The third layer 106 can be applied by wrapping the third strip 116 about the outer surface of the second layer 102. The third strip 116 can be helically applied. In some examples, the third strip 116 can be helically wrapped the second layer 104 such that each turn of the third strip 116 creates an overlap, which can include overlapping portions and overlapped portions of the third strip 116. In other examples, the third strip 116 can be helically wrapped around the second layer 104 such that each turn of the third strip 116 does not create any overlap and completely covers the outer surface of the second layer 104.

At step 234, a third treatment can be applied to the third layer 106. As discussed above, the treatment to the third layer 106 can include at least one or more of the following: application of thermal energy, application pressure, or application adhesive. The treatment of the third layer 106 can secure the edges of the third strip 116. In some examples, the third treatment can secure overlapping portions and the overlapped portions of the third strip 116. The third treatment can removably secure the edges of the third strip 116 to the outer surface of the third strip 116. Additionally and/or alternatively, the treatment of the third layer 106 can secure the third strip 116 to an outer surface of the second layer 104.

Alternatively, a single treatment can be applied to all of the layers after the third layer 106 has been applied. As discussed above, the single treatment can be a thermal treatment, application of pressure, application of adhesive, and the like. The single treatment can hold the layers (for example, the first layer 102, the second layer 104, and the third layer 106) together.

At step 236, the elongate core 150 can be removed. At step 238, one or more cuts can be applied to manufacture one or more biodegradable straws 100. The one or more cuts can be transversal with respect to an axis defined by the length of the biodegradable straw 100. As discussed above, a layer of impermeable and/or water resistant material can be applied to the biodegradable straws 100. This layer can be applied to the inner surface and/or the outer surface of the biodegradable straws 100.

Optionally, the completed tube (for example, the combination of the first layer 102, the second layer 104, and the third layer 106) can be cut into different lengths or the same length while still on the core 150. In this regard, the core 150 can be removed afterwards. Alternatively, the completed tube can be cut into different lengths or the same length after the core 150 is removed.

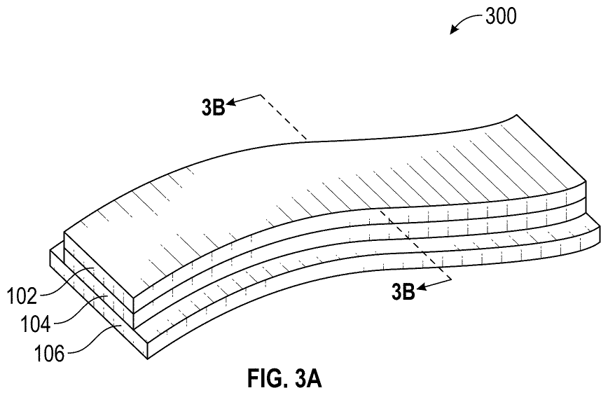

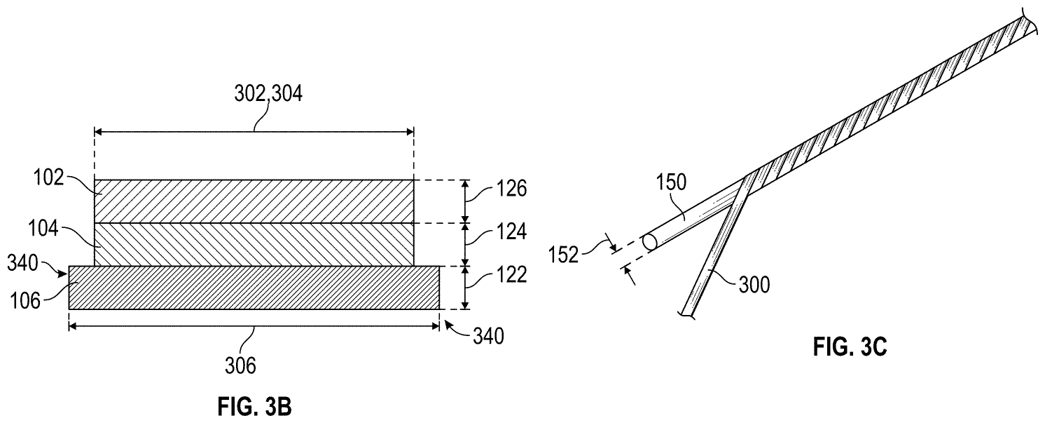

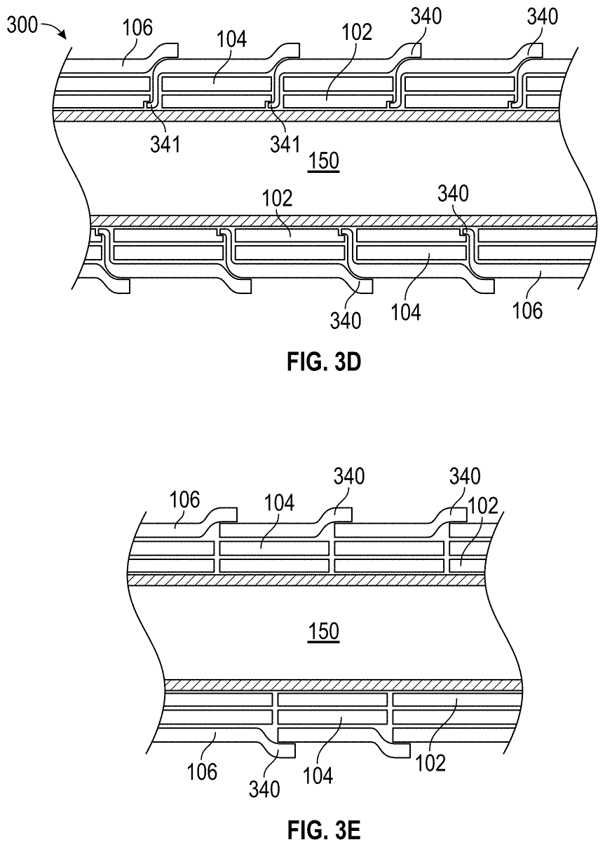

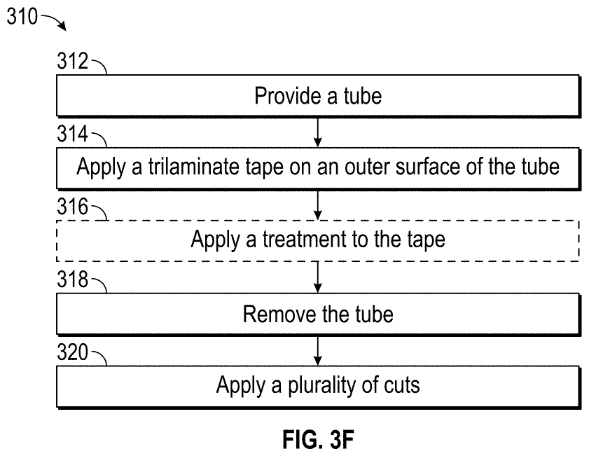

FIGS. 3A and 3B illustrate a multilayered strip 300 that can be used to manufacture the biodegradable straw of 100. The strip 300 can include the first layer 102, the second layer 104, and the third layer 106. As shown in FIG. 3B, the layers can be configured such that the second layer 104 is positioned between the first layer 102 and the third layer 106. The layers can be treated such that they are fixedly or removably secured to each other to form the strip 300. The layers can be removably secured to each other by application of compression force, adhesives, and/or thermal energy.

The strip 300 can be flexible. As discussed above, the first layer 102 and the third layer 106 of the strip 300 can be recyclable. The first layer 102 and the third layer 106 can be metallic. The first layer 102 and the third layer 106 can be made of the same material or different materials. The first layer 102 and the third layer 106 can have the same thickness or different thicknesses. In some examples, the first layer 102 and the third layer 106 both are aluminum foils.

The second layer 104 can be biodegradable and/or recyclable. The second layer 104 can have a thickness that is same or different from that of the first layer 102 and the third layer 106. The second layer 104 can be made from the same material as or different from the first layer 102 or the third layer 106. In some examples, the second layer 104 is made from a cardboard paper.

The first layer 102, the second layer 104, and the third layer 106 can have a first width 302, a second width 304, and third width 306. The widths 302, 304, 306 can vary between about 4 mm and about 30 mm, between about 8 mm and about 25 mm, between about 10 mm and about 20 mm, between about 12 mm and about 18 mm, or about 4 mm, 6 mm, 8 mm, 10 mm, 12 mm, 14 mm, 16 mm, 18 mm, 20 mm, 22 mm, 24 mm, 26 mm, 28 mm, 30 mm, or ranges between any two of the aforementioned values, or other widths. In some examples, the width 302 can be about one inch. In some embodiments, the layer 106 can be 1-2 mm wider than the widths 302, 304, on one or both sides. Thus, the width 306 can be 1-2 mm wider than widths 302, 304 or 2-4 mm wider. Other widths can also be used.

Optionally, the widths 302, 304, 306 of the layers 102, 104, 106 can be the same or different. In some examples, the third width 306 of the third layer 106 can be greater than the second width 304 and the first width 302 of the second layer 104 and the first layer 102, respectively. In this regard, the third layer 306 can include overhang 340 that extend beyond one or more edges of the second layer 104 and the first layer 102. The overhang 340 can extend beyond the one or more edges of the second layer 104 and the first layer 102 by between about 1 mm and about 2 mm. For example, the third width 306 can be between about 29 mm and about 27 mm while the first and the second widths 304, 302 can be about 25 mm.

Optionally, when the strip 300 is wrapped around the elongate core 150, the overhang 340 of the third layer 106 can be placed in contact with a side portion of the strip 300. In some examples, the overhang 340 can contact an outer surface of the elongate tube 150 to define an inner surface of the biodegradable straw 100.

Additionally and/or alternatively, the strip 300 can be wrapped such that the overhang 340 of the third layer 106 can overlap at least a portion of the outer surface of the third layer 106. A seal can be created between an overlapped portion of the third layer 106 and an overlapping portion of the third layer 106 by applying various types of treatments. In this regard, the overhang 340 can be used to create seals that can make the biodegradable straw 100 more water-resistant.

As shown in FIG. 3C, the strip 300 can be wrapped around the elongate core 150. The strip 300 can be helically wrapped around the elongate core 150. In some examples, each turn of the strip 300 creates an overlap of the strip 300. The overlap can include an overlapped portion and an overlapping portion of the strip 300. In some examples, each turn of the strip 300 does not create an overlap of the strip 300 and covers an outer surface of the elongate core 150 completely.

FIGS. 3D and 3E are cross-sectional views of various implementation of the biodegradable straw 100 manufactured with different embodiments of the strip 300. As disclosed above, the strip 300 can include the layers 102, 104, 106 that can be wrapped about the outer surface of the elongate core 150. The widths of the layers 102, 104, 106 can vary. Optionally, the width 306 of the third layer 106 can be greater than the widths 302, 304 of the first layer 102 and the second layer 104, respectively, such that the third layer 106 can include one or more overhangs 340 as shown in FIG. 3B.

FIG. 3D illustrates an example configuration of the strip 300 having two overhangs 340. As the strip 300 is wrapped around the elongate core 150, one of the two overhangs can be overlapped by a subsequent winding of the strip 300, while the other can overlap a previous winding of the strip 300. An overlapped overhang 341 can be overlapped by an adjacent first layer 102 (formed by a subsequent winding of the strip 300), adjacent second layer 104, and/or adjacent third layer 106. Optionally, the overlapped overhang 341 can be sufficiently long to contact the outer surface of the elongate core 150 as shown in FIG. 3D. In this regard, at least a portion of the overlapped overhang 340 can be overlapped by at least a portion of adjacent first layer 102 to create a seal. The seal can be water-proof.

An overlapping overhang 340 can overlap at least a portion of the outer surface of an adjacent third layer 106 (formed by a previous winding of the strip 300) as shown in FIG. 3D. The contact between the second overhang 340 and the portion of the outer surface of an adjacent third layer 106 can create a seal. The seal can be helical. Optionally, the seal can be water-proof. Additionally and/or alternatively, various types of treatments can be applied to create the seal.

FIG. 3E illustrates an example configuration of the straw manufactured with a strip 300 where the layer 106 is wider only on one side, forming only one overlapping overhang 340. As the strip 300 is wrapped around the elongate core 150, the overhang 340 can formed an overlapping overhang 340 as shown in FIG. 3E. The overlapping overhang 340 can overlap at least a portion of the outer surface of an adjacent third layer 106 (formed by a previous winding of the strip 300) as shown in FIG. 3E. The contact between the second overhang 340 and the portion of the outer surface of an adjacent third layer 106 can create a seal. The seal can be helical. Optionally, the seal can be water-proof. Additionally and/or alternatively, various types of treatments can be applied to create the seal.

The area of the overlapped portion of the third layer 106 shown in FIGS. 3D and 3E can be varied. In some examples, the overhang 340 can overlap between about 5% and about 20% of the width 306 of the third layer 106. Optionally, the overhang 340 can overlap about 15% of the width 306 of the third layer 106.

As illustrated in FIGS. 3D and 3E, the layers 102, 106, and 106 are formed from helical windings and are not entirely continuous. More specifically, adjacent windings of the strip 300 form spaced closely spaced and in some cases adjacent edges of the layers 102, 104, or 106 along the windings are separated by small portions of overhangs 340, 341. However, the majority of each layer, formed by windings that may be separated by a relatively small gap or a small amount of interstitial material, is aligned and co-axial. Thus, as used here, the term “layer” is intended to include layers formed by helical windings of laminated strips, such as the strip 300, even where formed by windings that may be separated by a relatively small gap or a small amount of interstitial material. The term “layer” can be considered as a separate tubular body formed by helical windings of laminated strips.

FIG. 3F illustrates another method 310 for manufacturing the biodegradable straw 100. At step 312, the elongate core 150 can be provided. At step 314, the strip 300 can be applied on the outer surface of the elongate core 150. As discussed above, the strip 300 can be helically wrapped around the elongate core 150 in various ways (for example, with or without overlap). Optionally, at step 316, a treatment can be applied to the strip 300. The treatment can hold the strip 300 in an elongate tubular form. In some examples, the treatment can secure each overlap of the strip 300 to hold the strip 300 in an elongate tubular form. In other examples, the treatment can secure edges of the strip 300 together to hold the strip 300 in an elongate tubular form. At step 318, the elongate core 150 can be removed, leaving behind helically wrapped strip 300. At step 320, one or more cuts can be made. The cuts can be transversal to an axis defined by the length of the helically wrapped strip 300.

Various other modifications, adaptations, and alternative designs are of course possible in light of the above teachings. Therefore, it should be understood at this time that within the scope of the appended list of embodiments the inventions disclosed herein can be practiced otherwise than as specifically described herein. It is contemplated that various combinations or subcombinations of the specific features and aspects of the embodiments disclosed above may be made and still fall within one or more of the inventions. Further, the disclosure herein of any particular feature, aspect, method, property, characteristic, quality, attribute, element, or the like in connection with an embodiment can be used in all other embodiments set forth herein. Accordingly, it should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above.

Moreover, while the inventions disclosed herein are susceptible to various modifications, and alternative forms, specific examples thereof have been shown in the drawings and are herein described in detail. It should be understood, however, that the inventions disclosed herein are not to be limited to the particular forms or methods disclosed, but to the contrary, the inventions cover all modifications, equivalents, and alternatives falling within the spirit and scope of the various embodiments described and the appended list of embodiments. Any methods disclosed herein need not be performed in the order recited. The methods disclosed herein include certain actions taken by a practitioner; however, they can also include any third-party instruction of those actions, either expressly or by implication. For example, actions such as “applying a first strip of a first waterproof material” includes “instructing the applying a first strip of a first waterproof material.”

The ranges disclosed herein also encompass any and all overlap, sub-ranges, and combinations thereof. Language such as “up to,” “at least,” “greater than,” “less than,” “between,” and the like includes the number recited. Numbers preceded by a term such as “approximately”, “about”, and “substantially” as used herein include the recited numbers (e.g., about 10%=10%), and also represent an amount close to the stated amount that still performs a desired function or achieves a desired result. For example, the terms “approximately”, “about”, and “substantially” may refer to an amount that is within less than 10% of, within less than 5% of, within less than 1% of, within less than 0.1% of, and within less than 0.01% of the stated amount.

What is claimed is:

1. A drinking straw comprising:
a tubular body of recyclable or biodegradable material, the tubular body comprising a first opening, a second opening, an intermediate section therebetween, the first opening associated with a first inner diameter and the second opening associated with a second inner diameter, the intermediate section defining a longitudinal axis and comprising a first length, the first inner diameter and the second inner diameter between about 4 mm and about 16 mm, the first length being between about 4 inches and about 18 inches;
a first metallic layer comprising a first metallic material secured to an inner surface of the tubular body between the first opening and the second opening, the first metallic layer extending along the inner surface with respect to the longitudinal axis and secured to the inner surface via a first treatment, the first metallic layer having a first thickness between about 0.010 mm and 0.030 mm, the first metallic strip and the first metallic layer being waterproof and removable from the tubular body; and
a second metallic layer comprising a second metallic material secured to an outer surface of the tubular body between the first opening and the second opening, the second metallic layer extending along the outer surface with respect to the longitudinal axis and secured to the outer surface via a second treatment, the first metallic layer characterized by a second thickness ranging between about 0.010 mm and 0.030 mm, the second metallic strip and the second metallic layer being waterproof and removable from the tubular body.

2. The drinking straw of Embodiment 1, wherein the first treatment and the second treatment comprises at least one of application of thermal treatment, application of compression force, and application of adhesive material.

3. The drinking straw of Embodiment 1, wherein the application of the first treatment seals a first plurality of overlaps of the first metallic strip, and wherein the application of the second treatment seals a second plurality of overlaps of the second metallic strip.

4. The drinking straw of Embodiment 1, further comprising a laminate layer covering an inner surface of the first metallic layer.

5. The drinking straw of Embodiment 1, wherein the first metallic layer extends helically along the inner surface at a first angle with respect to the longitudinal axis, and wherein the second metallic layer extends helically along the outer surface at a second angle with respect to the longitudinal axis.

6. A drinking straw comprising:
a first metallic layer comprising an inner surface and an outer surface;
a biodegradable layer comprising an inner surface and an outer surface, the inner surface of the biodegradable layer in contact with an outer surface of the first metallic layer.

7. The drinking straw of Embodiment 6, additionally comprising a second metallic layer comprising an inner surface and an outer surface, wherein the layer first metallic layer, the second metallic layer, and the biodegradable material is formed of a multilayered tape wrapped along a longitudinal axis such that the inner surface of the first metallic layer defines an inner tubular surface of a drinking straw and the outer surface of the second metallic layer defines an outer tubular surface of the drinking straw, wherein the multilayered tape is wrapped such that it defines a helical seam on the outer tubular surface the drinking straw.

8. The drinking straw of Embodiment 6, wherein a first treatment is applied to a helical seam of the drinking straw, and wherein the first treatment comprises at least one of applying compression force, applying thermal energy, and applying adhesive material.

9. The drinking straw of Embodiment 6, wherein the drinking straw has a first opining and a second opening, wherein the first opening has a first inner diameter and the second opening has a second inner diameter, and wherein the first inner diameter and the second inner diameter range between about 4 mm and about 16 mm.

10. The drinking straw of Embodiment 6, wherein the drinking straw has a length ranging between about 4 inches and about 12 inches.

11. The drinking straw of Embodiment 7, wherein the multilayered tape further comprises a laminate layer covering an inner surface of the first layer.

12. The drinking straw of Embodiment 6, additionally comprising a second metallic layer wherein the first metallic layer is characterized by a first thickness ranging between about 0.010 mm and about 0.030 mm, and wherein the second metallic layer is characterized by a second thickness ranging between about 0.010 mm and about 0.030 mm.

13. The drinking straw of Embodiment 6, additionally comprising a second metallic layer wherein the first metallic layer is characterized by a first width and the second metallic layer is characterized by a second width, and wherein the second metallic layer comprises one or more overhang.

14. The drinking straw of Embodiment 13, wherein the multilayered tape is wrapped around such that the overhang of the second metallic layer overlaps another portion of the second metallic layer, and wherein the overlapping to create the helical seam.

15. The drinking straw of Embodiment 6, additionally comprising a second metallic layer wherein the first and second metallic layers are waterproof.

16. A method of manufacturing a straw, the method comprising:
applying a first strip of a first metallic material about an outer surface of a rod to form a first layer, the first layer having an inner surface and an outer surface, the inner surface of the first layer positioned adjacent to the outer surface of the rod, the outer surface of the first layer positioned radially distal from the outer surface of the rod;
applying a second strip of a biodegradable material about the outer surface of the first layer to form a second layer, the second layer having an inner surface and an outer surface, the inner surface of the second layer positioned adjacent to the outer surface of the first layer, the outer surface of the second layer positioned radially distal from the outer surface of the first layer;
applying a first treatment to the first and second layers;
applying a third strip of a second metallic material about the outer surface of the second layer to form a third layer, the third layer having an inner surface and an outer surface, the inner surface of the third layer positioned adjacent to the outer surface of the second layer, the outer surface of the third layer positioned radially distal from the outer surface of the second layer;
applying a second treatment to the first, second, and third layers; and
removing the rod.

17. The method of Embodiment 16, wherein the biodegradable material is paper.

18. The method of Embodiment 16, further comprising applying a laminate layer to an inner surface of the first tubular layer.

19. The method of Embodiment 16, wherein the first and second treatments comprise at least one of applying compression force, applying thermal energy, and applying adhesive material.

20. The method of Embodiment 16, wherein the first strip extends helically along the outer surface of the rod at a first angle with respect to the longitudinal axis, wherein the second strip extends helically along the outer surface of the first layer at a second angle with respect to the longitudinal axis, and wherein the third strip extends helically along the outer surface of the second layer at a third angle with respect to the longitudinal axis.
